(19) United States
(12) Patent Application Publication
(10) Pub. No.: US 2019/0252948 A1
(43) Pub. Date: Aug. 15, 2019

(54) Portable Electricity Generator

(71) Applicants: Dominique Williams, Kansas City, MO (US); Anthony Dedmon, JR., Raytown, MO (US)

(72) Inventors: Dominique Williams, Kansas City, MO (US); Anthony Dedmon, JR., Raytown, MO (US)

(21) Appl. No.: 15/897,007

(22) Filed: Feb. 14, 2018

(51) Int. Cl. H02K 7/18; G05G 1/08; F03G 5/06

(52) U.S. Cl. CPC H02K 7/1861; F03G 2730/05; F03G 5/06; G05G 1/085

(57) ABSTRACT

A device for generating electricity whereby a manual crank is utilized to generate power to autonomous batteries coupled to electric motors that generate additional power that is sent through an amplifier and stored in lithium-ion batteries under liquid thermal control until such time as the electricity is dispersed for consumption.

### CROSS-REFERENCE TO RELATED APPLICATION(S)

Not applicable

### BACKGROUND OF THE INVENTION

### 1. Field of Invention

The present invention relates to the field electrical generators.

### 2. Description of Related Art.

Electrical generators are well known in the art. Home improvement stores across the globe sell generators ranging in size and power output, and typical generators use petroleum- based fuels to power an internal combustion engine for the purpose of creating usable electrical power. Recently, alternative methods of power creation have taken center-stage in research and development. Solar, wind and many other naturally occurring sources have been utilized to create energy in a manner that produces less carbon emissions from a typical internal combustion engine.

The advancements in lithium-ion batteries have provided a means for storing energy that was previously unavailable. Companies like Tesla™ have introduced products such as the Tesla Powerwall™ that utilize lithium-ion batteries with liquid thermal control in order to store large amounts of energy, such as what is required to power a home in the event of a power outage. Currently there is a need in the art for alternative methods for creating energy able to be stored in a lithium-ion battery. A novel generator, able to create and store clean and renewable energy, meets a need that exists in the art. The present invention addresses this need.

### BRIEF DESCRIPTION OF THE INVENTION

The present invention is a electrical generator, able to create, store and disperse clean and renewable energy. The design utilizes a manually operated crank to power a motor or series of motors that create energy with no emissions. The electricity created by the crank-driver motor or motors is then amplified and stored in a lithium-ion battery where it can be dispersed as needed to power an electrical device. The present invention has the advantage of scalability for use as a small portable device or a larger stationary device. As a small portable device, the present invention could be carried by a single user and quickly and efficiently power a cellular phone or other small electrical device when there is no access to a power outlet. In the larger scale, the device can be installed in a home, vehicle, RV or any other place and utilized to power larger electrical devices in the event of a power outage. By simply turning a crank, a user can generate and store clean and reliable electricity.

### BRIEF DESCRIPTION OF THE DRAWINGS

FIG. 1 is a schematic design of the present invention. The crank, 1, is operated by manually turning by a user. This is a three-phase process that results in energy being created in phase 1 and phase 2, and stored and dispersed in phase 3.

### DETAILED DESCRIPTION OF THE INVENTION

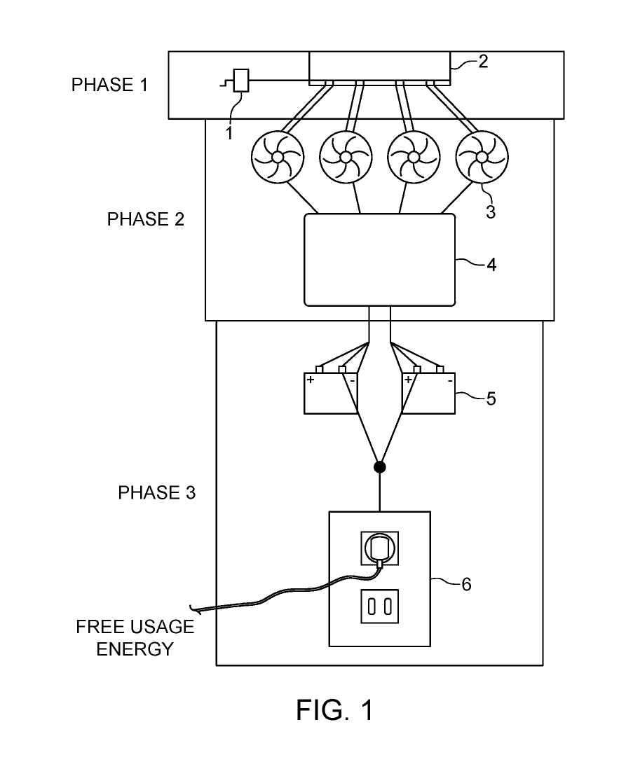

The present invention, in the preferred embodiment, is a three-phase device used to create, store and disperse electrical power. FIG. 1 is the schematic design of the invention in the preferred embodiment.

Phase 1, FIG. 1, is responsible for the creation of the energy. The crank, 1, is turned manually by a user to power at least one autonomous battery, 2. Phase 2, FIG. 1, utilizes the power to operate at least one motor, 3. In the preferred embodiment, a series of motors is utilized, 3. The motors operate to create electricity that is coupled to an amplifier, 4. The electricity from the amplifier, 4, is then stored in at least one lithium-ion battery with thermal control, 5. The electricity from the lithium-ion battery can then be accessed from a typical electrical outlet, 6 for consumption.

Once the crank is operated for a short time, 60 seconds for the preferred embodiment to several minutes for a very large embodiment of the invention, the autonomous batteries, 2, are charged as the at least one operates. The alternator on the motors continuously charges the autonomous battery or batteries as the motors continue to supply power to the amplifier, 4, that charges the lithium-ion batteries, 5.

In the preferred embodiment, the present invention can generate electricity sufficient to power a home for up to a month after operating the crank for 30 to 60 seconds. In a large-scale embodiment of the present invention, a mobile hospital could operate for a week or more. The applications for the present invention are plentiful. This technology can be used to power any device that uses electricity for power. Virtually any vehicle, boat, airplane, or any electronic device can benefit from the present invention. Clean, reliable energy is produced with minimal manual labor.

We claim:

1. A device for generating electricity comprising:
a crank able to be turned by a user;
at east one autonomous battery coupled to the crank;
at least one motor coupled to the at least one autonomous battery whereby the motor is powered by the at least one autonomous battery;
an alternator coupled to the motor whereby the alternator charges the at least one autonomous battery;
a electrical amplifier coupled to the at least one motor;
at least one lithium-ion battery coupled to the amplifier; and
a means for transferring the electricity stored in the at least one lithium-ion battery to a device powered by electricity.

2. The device for generating electricity in claim 1, further comprising a connective outlet whereby the electricity from the device can be channeled into the existing circuitry of a building for the purpose of supplying electricity to the entire building.

3. The device for generating electricity in claim 1, further comprising an electrical outlet whereby at least one electrical device can be powered by the electricity stored in the at least lithium-ion battery.

4. The method for generating electricity comprising:
turning a crank by a user to power at least one autonomous battery and start at least one motor;
generating electricity by at least one autonomous motor;
transferring electricity by the at least one autonomous motor to an amplifier;
amplifying the electricity by the amplifier;
transferring the electricity by the amplifier to at least one lithium-ion battery;
storing the electricity by the at least one lithium-ion battery; and
dispersing the electricity through outlet for consumption.
